(19) United States
(12) Patent Application Publication
(10) Pub. No.: US 2023/0268536 A1
(43) Pub. Date: Aug. 24, 2023

(54) FUEL CELL VEHICLE FREEZE START UP INHIBITION

(71) Applicant: FORD GLOBAL TECHNOLOGIES, LLC, Dearborn, MI (US)

(72) Inventors: Hao WANG, Ann Arbor, MI (US); Jason MEYER, Canton, MI (US); Rajit JOHRI, SAN FRANCISCO, CA (US); Zeng QIU, Grosse Pointe Woods, MI (US)

(21) Appl. No.: 17/676,492

(22) Filed: Feb. 21, 2022

(51) Int. Cl. H01M 8/04955; H01M 8/04701; H01M 8/04992; H01M 8/043

(52) U.S. Cl. CPC H01M 8/04955; H01M 8/04731; H01M 8/04992; H01M 8/043; H01M 2250/20

(57) ABSTRACT

A vehicle includes a motor, a battery, a fuel cell stack, and a controller. The battery is configured to supply power to the motor to propel the vehicle. The fuel cell stack is configured to generate power to charge the battery. The controller is programmed to, while traversing a route with the fuel cell stack not operating and, responsive to data indicative of a predicted distance to empty at an end of the route being greater than a distance threshold, inhibit starting of the fuel cell stack during the traversing.

### TECHNICAL FIELD

The present disclosure relates to vehicle fuel cell system.

### BACKGROUND

A fuel cell vehicle relies on a fuel cell system (e.g. fuel cell stacks) to generate electricity from fuel such as hydrogen. To meet the operation requirements, the fuel cell system needs to operate across a wide range of ambient conditions, including freeze start-up (FSU) when the ambient temperature is low. Freeze start-ups under extreme low temperature (e.g. −30° C.) may be challenging and may introduce accelerated degradation to the fuel cell stacks.

### SUMMARY

A vehicle includes a motor, a battery, a fuel cell stack, and a controller. The battery is configured to supply power to the motor to propel the vehicle. The fuel cell stack is configured to generate power to charge the battery. The controller is programmed to, while traversing a route with the fuel cell stack not operating and, responsive to data indicative of a predicted distance to empty at an end of the route being greater than a distance threshold, inhibit starting of the fuel cell stack during the traversing.

A method for a vehicle having a fuel cell stack and a battery includes traversing a route using electric power from the battery alone while the fuel cell stack is not operating. The method further includes responsive to data indicative of temperature of the fuel cell stack being below a temperature threshold and a first predicted power demand on the route being less than an available power from the battery, inhibit starting of the fuel cell stack during the traversing.

A vehicle system includes a motor, a battery, a fuel cell system, and a controller. The battery is configured to supply power to the motor to propel the vehicle system. The fuel cell system is configured to generate power to charge the battery. The controller is programmed to, while traversing a route with the fuel cell stack not operating and, responsive to data indicative of an event that a first predicted power demand on the route is greater than an available power from the battery, and a probability for the event to occur is less than a probability threshold, inhibit starting of the fuel cell stack during the traversing.

### BRIEF DESCRIPTION OF THE DRAWINGS

FIG. 1 illustrates an example block diagram fuel cell electric vehicle having a fuel cell system and a traction battery.

FIG. 2 illustrates an example block topology of a vehicle system.

FIG. 3 illustrates a flow diagram of a process for inhibiting freeze start-ups for the fuel cell system.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

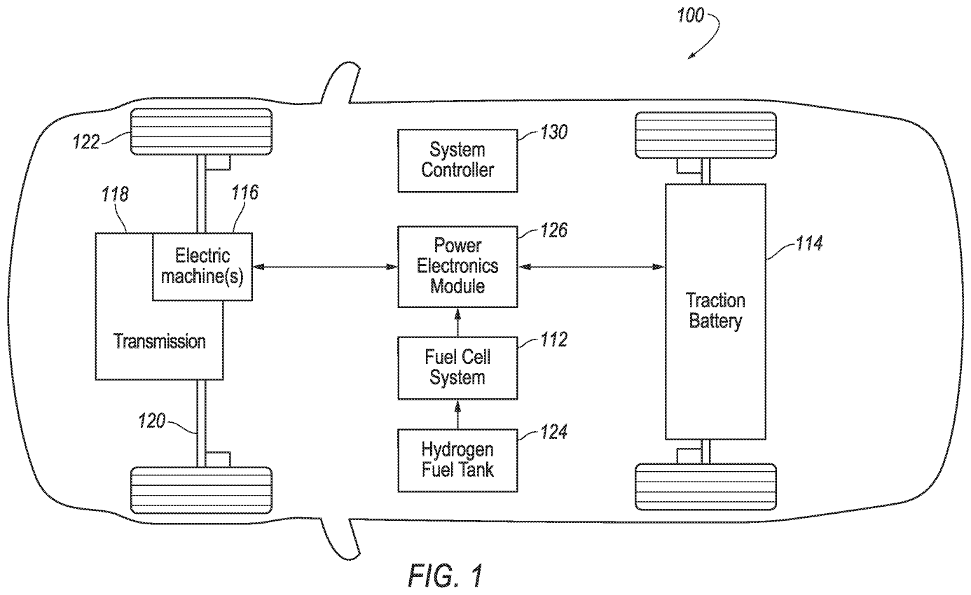

Referring now to FIG. 1, a block diagram of an exemplary fuel cell electric vehicle (FCEV) 100 having a fuel cell system 112 and a traction battery 114 is illustrated. The fuel cell system 112 and the traction battery 114 are individually operable for providing electrical energy for propulsion of the FCEV 100.

The fuel cell system 112 includes one or more fuel cell stacks (not shown). Each fuel cell stack may include a plurality of fuel cells electrically connected in series. For simplicity, the fuel cell system 112 is described herein as having one fuel cell stack although the present disclosure is not limited thereto. The fuel cell system 112 further includes auxiliary equipment such as an electric compressor for the fuel cell system air supply.

The FCEV 100 may further include one or more electric machines 116 mechanically connected to a transmission 118. The electric machine 116 may be capable of operating as a motor and as a generator. The transmission 118 is mechanically connected to a drive shaft 120 mechanically connected to wheels 122 of the FCEV 110. The electric machine 116 may provide propulsion and slowing capability for the FCEV 10. The electric machine 116 acting as a generator may recover energy that may normally be lost as heat in a friction braking system. The energy recovered by the electric machine 116 may be used to recharge the traction battery 114.

The fuel cell system 112 may be configured to convert hydrogen from a hydrogen fuel tank 24 of the FCEV 100 into electrical energy. The electrical energy from the fuel cell system 112 may be used by the electric machine 116 for propelling the FCEV 100 and/or for recharging the traction battery 114. The fuel cell system 112 may be electrically connected to the electric machine 116 via a power electronics module 126 of the FCEV 100. The power electronics module 126, having an inverter or the like, may provide the ability to transfer electrical energy from the fuel cell system 112 to the electric machine 116. For example, The fuel cell system 112 may provide direct current (DC) electrical energy while the electric machine 116 may require three-phase alternating current (AC) electrical energy to function. The power electronics module 126 may convert the electrical energy from the fuel cell system 112 into electrical energy having a form compatible for operating the electric machine 116. In this way, the FCEV 100 may be configured to be propelled with use of electrical energy from the fuel cell system 112.

The battery 114 may store electrical energy for use by the electric machine 116 for propelling the FCEV 100. The battery 114 may be also electrically connected to the electric machine 116 via the power electronics module 126. The power electronics module 126 may provide the ability to bi-directionally transfer electrical energy between the battery 114 and the electric machine 116. For example, the battery 114 may also provide DC electrical energy while the electric machine 116 may require the three-phase AC electrical energy to function. The power electronics module 126 may convert the electrical energy from the battery 114 into electrical energy having a form compatible for operating the electric machine 116. In this way, the FCEV 100 may be further configured to be propelled with the use of the battery 114 individually or in combination with the fuel cell system 112. Further, in a regenerative mode, the power electronics module 126 may convert AC electrical energy from the electric machine 116 acting as a generator to DC electrical energy compatible with the battery 114.

The fuel cell system 112 and the battery 114 may have one or more associated controllers to control and monitor the operation thereof. The controllers may be microprocessor-based devices. The controllers may communicate via a serial bus (e.g., Controller Area Network (CAN)) or via discrete conductors.

For example, a system controller 130 (i.e., a vehicle controller) may be configured to coordinate the operation of the fuel cell system 112 and the battery 114. The system controller 130 may be further configured to control the fuel cell system 112 and the battery 114 accordingly. In operation for propelling the FCEV 100, the system controller 130 may interpret and split a driver power demand into a fuel cell system power request and a battery power request. In turn, the fuel cell system 112 may be controlled to output electrical power corresponding to the fuel cell system power request to the electric machine 116 for use in propelling the FCEV 100. Likewise, the battery 114 may be controlled to output electrical power corresponding to the battery power request to the electric machine 116 for use in propelling the FCEV 100. It is noted that the term system controller 130 is used as a general term in the present disclosure and may be implemented as one or more controllers, processors or any device having data processing and communication capabilities to operate and control various operations of the FCEV 100.

As noted above, the fuel cell system 112 may include a fuel cell stack including a series connection of a plurality of fuel cells. The voltage of each of the fuel cells may depend on various factors including cell temperature, membrane humidity, pressure, anode hydrogen concentration, air flow rate, current or the like. As an example, the voltage of one of the fuel cells may be most sensitive and responsive to the current of the fuel cell.

As the fuel cells of a fuel cell stack are connected in series, the voltage of the fuel cell stack may be a summation of all of the voltages of the fuel cells of the fuel cell stack. Likewise, as the fuel cells of the fuel cell stack are connected in series, each fuel cell may have the same current, and the current of the fuel cell stack may be the same as the current of each of the fuel cells. The power delivered by the fuel cell stack may be equal to the stack voltage multiplied by the stack current.

The fuel cell system 112 may be configured to operate in various conditions including freeze start-up. When the ambient temperature is below a predefined threshold, starting the fuel cell system 112 from a non-operating state to an operating state may be difficult. Furthermore, starting the fuel cell system 112 in such a non-preferable condition may introduce accelerated degradation to the fuel cell stack, due to the undesired membrane icing condition and increased chance of cell voltage reversal. Therefore, it may be preferable to minimize the total number of freeze start-up operations for the fuel cell system 112 over the lifespan of the FCEV 100 such that the durability and performance of the fuel cell system 112 may be improved. The present disclosure proposes a system and method for determining if a freeze start-up operation can be inhibited or delayed based on both local and remote information.

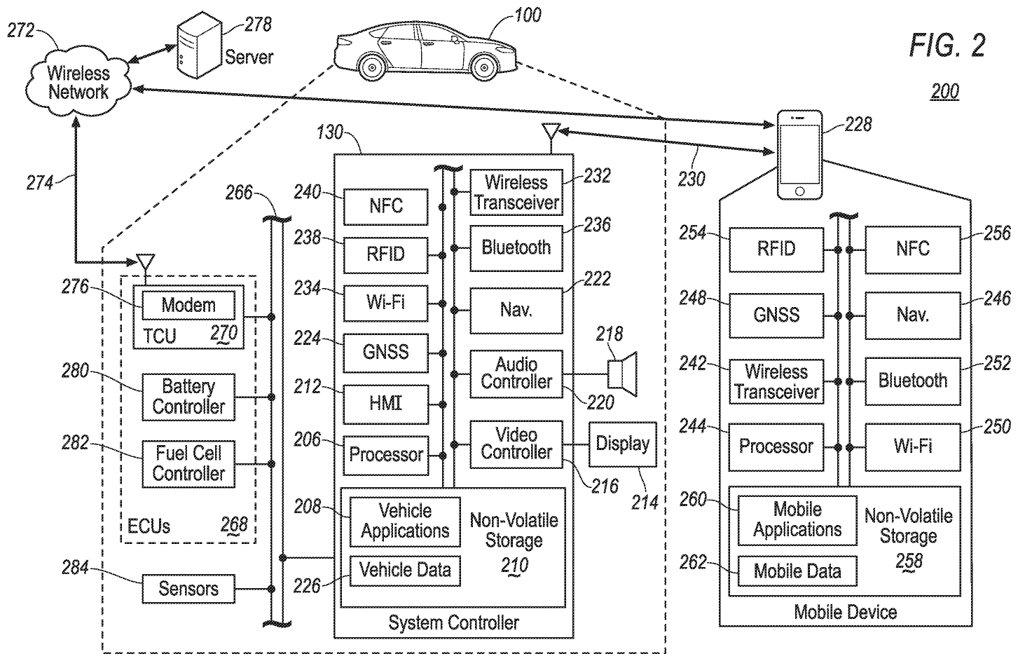

Referring to FIG. 2, an example block topology of a vehicle system 200 of one embodiment of the present disclosure is illustrated. With continuing reference to FIG. 1, the system controller 130 may include one or more processors 206 configured to perform instructions, commands, and other routines in support of the processes described herein. For instance, the system controller 130 may be configured to execute instructions of vehicle applications 208 to provide features such as navigation, remote controls, and wireless communications. Such instructions and other data may be maintained in a non-volatile manner using a variety of types of computer-readable storage medium 210. The computer-readable medium 210 (also referred to as a processor-readable medium or storage) includes any non-transitory medium (e.g., tangible medium) that participates in providing instructions or other data that may be read by the processor 206 of the system controller 130. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

The system controller 130 may be provided with various features allowing the vehicle occupants/users to interface with the system controller 130. For example, the system controller 130 may receive input from HMI controls 212 configured to provide for occupant interaction with the FCEV 100. As an example, the system controller 130 may interface with one or more buttons, switches, knobs, or other HMI controls configured to invoke functions on the system controller 130 (e.g., steering wheel audio buttons, a push-to-talk button, instrument panel controls, etc.).

The system controller 130 may also drive or otherwise communicate with one or more displays 214 configured to provide visual output to vehicle occupants by way of a video controller 216. In some cases, the display 214 may be a touch screen further configured to receive user touch input via the video controller 216, while in other cases the display 214 may be a display only, without touch input capabilities. The system controller 130 may also drive or otherwise communicate with one or more speakers 218 configured to provide audio output and input to vehicle occupants by way of an audio controller 220.

The system controller 130 may also be provided with navigation and route planning features through a navigation controller 222 configured to calculate navigation routes responsive to user input via, for example, the HMI controls 212, and output planned routes and instructions via the speaker 218 and the display 214. Location data that is needed for navigation may be collected from a global navigation satellite system (GNSS) controller 224 configured to communicate with multiple satellites and calculate the location of the FCEV 100. The GNSS controller 224 may be configured to support various current and/or future global or regional location systems such as global positioning system (GPS), Galileo, Beidou, Global Navigation Satellite System (GLONASS) and the like. Map data used for route planning may be stored in the storage 210 as a part of the vehicle data 226. Navigation software may be stored in the storage 210 as one of the vehicle applications 208.

The system controller 130 may be configured to wirelessly communicate with a mobile device 228 of the vehicle users/occupants via a wireless connection 230. The mobile device 228 may be any of various types of portable computing devices, such as cellular phones, tablet computers, wearable devices, smart watches, smart fobs, laptop computers, portable music players, or other devices capable of communication with the system controller 130. A wireless transceiver 232 may be in communication with a Wi-Fi controller 234, a Bluetooth controller 236, a radio-frequency identification (RFID) controller 238, a near-field communication (NFC) controller 240, and other controllers such as a Zigbee transceiver, an IrDA transceiver, an ultra-wide band (UWB) controller (not shown), and be configured to communicate with a compatible wireless transceiver 242 of the mobile device 228.

The mobile device 228 may be provided with a processor 244 configured to perform instructions, commands, and other routines in support of the processes such as navigation, telephone, wireless communication, and multi-media processing. For instance, the mobile device 228 may be provided with location and navigation functions via a navigation controller 246 and a GNSS controller 248. The mobile device 228 may be provided with the wireless transceiver 242 in communication with a Wi-Fi controller 250, a Bluetooth controller 252, an RFID controller 254, an NFC controller 256, and other controllers (not shown), configured to communicate with the wireless transceiver 232 of the system controller 130. The mobile device 228 may be further provided with non-volatile storage 258 to store various mobile application 260 and mobile data 262.

The system controller 130 may be further configured to communicate with various components of the FCEV 100 via one or more in-vehicle networks 266. The in-vehicle network 266 may include, but is not limited to, one or more of a controller area network (CAN), an Ethernet network, and a media-oriented system transport (MOST), as some examples. Furthermore, the in-vehicle network 266, or portions of the in-vehicle network 266, may be a wireless network accomplished via Bluetooth low-energy (BLE), Wi-Fi, UWB, or the like.

The system controller 130 may be configured to communicate with various electronic control units (ECUs) 268 of the FCEV 100 configured to perform various operations. As discussed above, the system controller 130 may be configured to communicate with the PCM 148 via the in-vehicle network 266. The system controller 130 may be further configured to communicate with a telematics control unit (TCU) 270 configured to control telecommunication between FCEV 100 and a wireless network 272 through a wireless connection 274 using a modem 276. The wireless connection 274 may be in the form of various communication networks, for example, a cellular network. Through the wireless network 272, the vehicle may access one or more cloud servers 278 to access various content for various purposes. It is noted that the terms wireless network, cloud and server are used as general terms in the present disclosure and may include any computing network involving carriers, router, computers, controllers, circuitry or the like configured to store data and perform data processing functions and facilitate communication between various entities. The ECUs 268 may further include a battery controller 280 configured to monitor and control various operations of the traction battery 114. For instance, the battery controller 280 may configured to operate the charging and discharging, and monitor the status of charge (SOC) of the traction battery 114. The ECUs 268 may further include a fuel cell controller 282 configured to monitor and control various operations of the fuel cell system 112. For instance, the fuel cell controller 282 may be configured to start the fuel cell system 112 from a non-operating state to an operating state based on various parameters received from the cloud 278 as well as other controllers of the FVEC 100 (to be described in details below). The ECUs 268 may be provided with or connected to one or more sensors 284 providing signals related to the operation of the specific ECU 268. For instance, the sensors 282 may include an ambient temperature sensor configured to measure the ambient temperature of the FCEV 100. The sensors 282 may further include one or more engine/coolant temperature sensors configured to measure the temperature of the fuel cell system coolant and provide such data to the fuel cell controller 282.

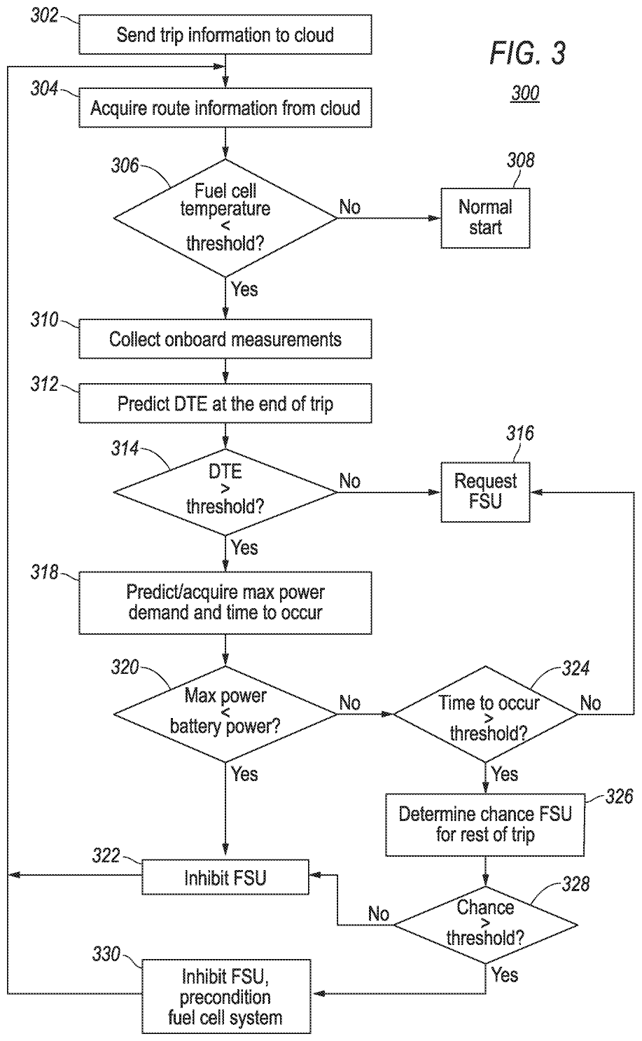

Referring to FIG. 3, an example flow diagram of a process 300 for inhibiting a freeze start-up for the fuel cell system is illustrated. With continuing reference to FIGS. 1 and 2, operations of the process 300 may be performed by various controllers/ECUs of the FCEV 100 individually or collectively. In addition, operations of the process 300 may also be performed in the cloud in communication with the FCEV 100. It is noted the following description is merely an example of the present disclosure and should be interpreted as for illustration purposes. The following description should not be interpreted as limitations to the scope of the present disclosure.

At operation 302, the system controller 130 sends/uploads information with regard to an upcoming trip to the cloud server 278. For instance, the trip may include a route having a destination planned by the navigation controller 222 in response to receiving a user input. Additionally or alternatively, the trip may be automatically planned and scheduled by the system controller 130 based on historical data (e.g. the user usually drives to work/home at a predefined time). Additionally or alternatively, the trip information may be originated from the mobile device 228 associated with the FCEV 100. At operation 304, the system controller 130 receives/acquires route information associated with the trip from the cloud server 278. The route information may include various types of information and vary depending on the specific implementation of the process 300. For instance, the route information may include weather and traffic information on the route on which the FCEV 100 is anticipated to traverse. Additionally, the route information may include a predicted energy consumption for the trip as planned. The route may be broken into a plurality of sections each corresponding to a predicted energy consumption. The route information may further include a predicted power demand corresponding to a location on the route and a time to occur. Additionally, assuming the FCEV 100 is to be operated under the EV mode only (i.e. only using the power from the traction battery 114 without starting the fuel cell system 112), the route information may further include a distance to empty (DTE) at various sections on the route including the distance to empty at the end of the trip. The system controller 130 may be configured to acquire the route information at once at the beginning of the trip. Alternatively, the system controller 130 may be configured to continue to acquire the updated version of the route information while traveling on the route until the trip is completed. It is noted that the route information discussed above is merely an example and the FCEV 100 may be configured to acquire more or less types of route information from the cloud server 278. In an alternative example, some types of route information may be determined by the vehicle in addition to, or in lieu of, by the cloud server 278 (to be discussed in detail below).

At operation 306, the fuel cell controller 282 of the FCEV 100 verifies if the current fuel cell temperature is below a temperature threshold (e.g. 2° C.) that qualifies as a temperature condition for freeze start-up operations. For instance, the fuel cell temperature may be directly measured by the fuel cell temperature sensor 284. Additionally or alternatively, the fuel cell temperature may be indirectly estimated by a fuel cell stack coolant temperature measured by the coolant temperature sensor 284, or by ambient temperature as measured by the ambient temperature sensor 284. If the answer for operation 306 is No, indicative of the temperature being sufficiently high to avoid freeze start-ups, the process proceeds to operation 308 and the fuel cell controller 282 may allow the fuel cell system 112 to start as normal. Otherwise, if the answer for operation 306 is Yes, indicative of the freeze start-up temperature condition being met, the process proceeds to operation 310 and the system controller 130 collects onboard vehicle data measurements to facilitate further determinations. Various onboard vehicle data measurements may be collected. For instance, the system control 130 may collect a battery SOC, voltage, current, and temperature from the battery controller 280, a current and average vehicle speed from the speed sensor 284, and a distance to the destination of the trip from the navigation controller 222. Based on the onboard data as collected, at operation 312, the system controller may calculate and determine a distance to empty at the end of the current trip without starting the fuel cell system 112. The distance to empty may be calculated in various manners. As an example, the distance to empty at the end of the trip may be calculated using the following equation:

DTE_{EV,end_trip}=(C_{batt}*V_{batt}*SOC−E_{trip_left})/η_{beyond_trip} (1)

wherein C_{batt} denotes the capacity of the battery 114 in units of ampere-hours (Ah); V_{batt} denotes the voltage measurements of the battery 114 in unites of volts (V); E_{trip_left} denotes an estimated amount of energy required to complete the trip in units of watt-hour per kilometer (Wh/km); and η_{beyond_trip} in units of watt-hours per kilometer (Wh/km) denotes an estimation of the vehicle efficiency beyond the completion of the current trip that may be learned from a recent vehicle usage profile by the system controller 130. The system controller 130 may repeat the process to estimate the distance to empty at the end of the trip in a regular time interval (e.g. every 1 minute) to improve the accuracy of the estimation. The estimated amount of energy required to complete the trip E_{trip_left} may be determined using distance-based trajectories for the energy consumptions and an average vehicle speed acquired from the server 278. Additionally, or alternatively, the entire or a part of operation 312 may be performed remotely in the cloud server 278 and the system controller 130 may acquire the distance to empty form the server 278 at a regular time interval.

At operation 314, the system controller 130 compares the distance to empty at the end of the trip with a predefined threshold (e.g. 10 km) to determine if the battery 114 has sufficient charge to start the vehicle and travel at least a part of the next trip (e.g. to travel 10 km). If the answer is No indicating more charge is required, the process proceeds to operation 316 and the fuel cell controller 282 performs the freeze start-up operation to the fuel cell system 112. If the answer for operation 304 is Yes, the process proceeds to operation 318 and the system controller 130 predicts and/or acquires a predicated maximum power demand for the remainder of the trip and the time that the demand is to occur T_{max_power}. There may be situations in which the battery 114 has sufficient energy for the route but the power output in the EV mode alone would be insufficient (e.g. climbing a big hill). Similar to operation 312, here, operation 318 may be performed by the system controller 130, or by the cloud server 278, or a combination thereof. For simplicity purposes, the following description will be made assuming that operation 312 is performed by the system controller 130. As discussed above, the route may be divided into a plurality of sections, each associated with a predicted energy consumption amount E_{pred} in units of watt-hours per kilometer (Wh/km) and a predicted average vehicle speed v_{pred_avg} in units of kilometers per hour (km/h). A time-based trajectory of the vehicle power usage P_{pred} for the corresponding section of the route may be calculated using the equation below:

P_{pred}=E_{pred}×v_{pred_avg} (2)

The above calculation may be repeated at a regular time interval (e.g. every 1 minute) based on the current location of the FCEV 100. The predicated maximum power demand P_{max, trip_left} and the time the demand is to occur T_{max_power} may be extracted for each section using the time-based trajectory of the vehicle power usage P_{pred} discussed above.

At operation 320, the system controller 130 compares the predicted maximum power demand P_{max, trip_left} against the available battery power determined by the battery controller 280 using parameters such as SOC, temperature or the like. If the predicated maximum power demand P_{max, trip_left} is less than the available battery power, which is indicative of the battery power in the EV mode alone being sufficient to complete each section of the trip, the process proceeds to operation 322 and the fuel cell controller 282 prohibits the freeze start-up operations during the trip. Otherwise, if the answer for operation 320 is No, which is indicative of the battery power alone being insufficient to complete each section of the trip, the process proceeds to operation 324 and the system controller 130 further determines whether the predicted maximum power demand P_{max, trip_left} is to occur soon from the current time by comparing the time to occur T_{max_power} with a time threshold (e.g. 2 minutes). If the time that the maximum power demand predicted to occur T_{max_power} is less than the threshold, the process returns to operation 316 and the fuel cell controller 282 performs the freeze start-up operations. Otherwise, if the time to occur T_{max_power} is greater than the threshold, the process proceeds to operation 326 to further determine a probability indicative of how much chance that a freeze start-up operation is needed for the remainder of the trip. The probability may be dependent on factors including the length of the remainder of the trip. For instance, a longer remainder may increase the probability that freeze start-up is to occur whereas a shorter remainder may decrease the probability. The probability may be further affected by the amount of power shortage determined at operation 320. If the predicated maximum power demand P_{max, trip_left} is significantly more than the available battery power, the freeze start-up is more likely to occur. At operation 328, the system controller 130 compares the probability with a predetermined threshold. If the probability is less than the threshold, which is indicative of the freeze start-up having a low chance to occur during the remainder of the trip, the process proceeds to operation 322 and the fuel cell controller 282 inhibits the fuel cell system 112 to perform freeze start-up operations. Otherwise, if the probability indicates a high chance of freeze start-up, the process proceeds to operation 330 and the fuel cell controller 282 inhibits the freeze start-up while starting to precondition the fuel cell system. There are several methods in which the preconditioning process may be performed. For instance, the fuel cell controller 282 may activate a heater (not shown) attached to the fuel cell stack to warm up the fuel cell system 112 in preparation for the predicted freeze start-up in the near future.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a motor;
a battery configured to supply power to the motor to propel the vehicle;
a fuel cell stack configured to generate power to charge the battery; and
a controller programmed to, while traversing a route with the fuel cell stack not operating and, responsive to data indicative of a predicted distance to empty at an end of the route being greater than a distance threshold, inhibit starting of the fuel cell stack during the traversing.

2. The vehicle of claim 1, wherein the data is further indicative of a predicted power demand on the route being less than an available power from the battery.

3. The vehicle of claim 2, wherein the predicted power demand is received from a cloud server.

4. The vehicle of claim 1, wherein the data is further indicative of an event that a predicted power demand on the route is greater than an available power from the battery, and a probability for the event to occur is less than a probability threshold.

5. The vehicle of claim 4, wherein the data is further indicative of a time for the event to occur from a current time being longer than a time threshold.

6. The vehicle of claim 4, wherein the controller is further programmed to precondition the fuel cell stack responsive to an updated probability for the event to occur having increased to greater than the probability threshold.

7. The vehicle of claim 1, wherein the distance to empty is calculated by the controller using an average speed on the route received from a cloud server.

8. A method for a vehicle having a fuel cell stack and a battery, comprising:
traversing a route using electric power from the battery alone while the fuel cell stack is not operating; and
responsive to data indicative of temperature of the fuel cell stack being below a temperature threshold and a first predicted power demand on the route being less than an available power from the battery, inhibit starting of the fuel cell stack during the traversing.

9. The method of claim 8, wherein the data is further indicative of an event that a second predicted power demand on the route is greater than the available power from the battery, and a probability for the event to occur is less than a probability threshold.

10. The method of claim 9, wherein the data is further indicative of a time for the event to occur from a current time being longer than a time threshold.

11. The method of claim 9 further comprising preconditioning the fuel cell stack responsive to an updated probability for the event to occur having increased to greater than the probability threshold.

12. The method of claim 8, wherein the data is further indicative of a predicted distance to empty of battery charge at an end of the route being greater than a distance threshold,

13. The method of claim 12, wherein the distance to empty is calculated onboard the vehicle using an average speed on the route received from a cloud server.

14. The method of claim 8, wherein the predicted power demand is received from a cloud server.

15. A vehicle system comprising:
a motor;
a battery configured to supply power to the motor to propel the vehicle system;
a fuel cell system configured to generate power to charge the battery; and
a controller programmed to, while traversing a route with the fuel cell stack not operating and, responsive to data indicative of an event that a first predicted power demand on the route is greater than an available power from the battery, and a probability for the event to occur is less than a probability threshold, inhibit starting of the fuel cell stack during the traversing.

16. The vehicle system of claim 15, wherein the data is further indicative of a time for the event to occur from a current time being longer than a time threshold.

17. The vehicle system of claim 15, wherein the controller is further programmed to precondition the fuel cell stack responsive to an updated probability for the event to occur having increased to greater than the probability threshold.

18. The vehicle system of claim 15, wherein the data is further indicative of a second predicted power demand on the route being less than the available power from the battery.

19. The vehicle system of claim 15, wherein the data is further indicative of a predicted distance to empty of battery charge at an end of the route being greater than a distance threshold.

20. The vehicle system of claim 15 further comprising a wireless transceiver configured to communicate with a cloud server, wherein the predicted power demand is received from the cloud server.
